(19) United States
(12) Patent Application Publication
(10) Pub. No.: US 2020/0138674 A1
(43) Pub. Date: May 7, 2020

(54) Saliva dispenser

(71) Applicant: Nathaniel Freeman, Needville, TX (US)

(72) Inventor: Nathaniel Freeman, Needville, TX (US)

(21) Appl. No.: 16/350,331

(22) Filed: Nov. 2, 2018

(51) Int. Cl. A61J 19/02; A61J 19/04

(52) U.S. Cl. CPC A61J 19/02; A61J 19/04

(57) ABSTRACT

A Saliva Dispenser includes:

A funnel, a pumping system, a power source, a fresh rinse container and collection container. The salvia dispenser is designed to collect and contain the saliva of individuals that need this service to be collected and disposed of in a sanitary method. The unit may be powered by AC or DC power source. The unit can be a stationary fixture or portable for travel with the individual. The funnel may be designed to detatch from the top disinfectant ring for cleaning purposes or disposal of after use. The unit may consist of rechargeable batteries that can be recharged from a normal 110 outlet, or plugged directly into a 110 outlet for operation on fixed style units.

### SUMMARY OF THE INVENTION

Embodiments of the present invention known as the Saliva dispenser consist of:

A funnel, a pumping system, a power source, a fresh rinse container and collection container. The salvia dispenser is designed to collect and contain the saliva of individuals that need this service to be collected and disposed of in a sanitary method. The unit may be powered by AC or DC power source. The unit can be a stationary fixture or portable for travel with the individual. The funnel may be designed to detatch from the top disinfectant ring for cleaning purposes or disposal of after use. The unit may consist of rechargeable batteries that can be recharged from a normal 110 outlet, or plugged directly into a 110 outlet for operation on fixed style units. The unit may consist if a sensor that would activate the cleansing flow of liquid used to rinse saliva into bowl.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrated only typical embodiments of this invention and are therefore not to be considered limiting of its scope, for the invention may admit to other equally effective embodiments.

FIG. 1—100—Is the external view of the Saliva Dispenser Bowl according to the present invention, formed of hard plastic by injection molding process.
101—References the height of the bowl—5″-7″ which may vary in height according to application.
102— Notes the receptacle opening that is the diameter of the bowl size 4″-8″
103— The handle which is a separate unit from the 100 bowl molding which houses the control features listed in 104
104— Optional control switch used to operate the electric 12 volt switch ON-OFF functions manually.
104a— Removable control handle head allows for ease of clean up and storage.
104b— Rinsing ring with sensor that activates the flow of rinsing agent at the presents of salvia across the ring surface.
105— Opening located at the bottom of the 100 bowl unit, which may contain a quick connection at the bottom of the bowl for replaceable discharge hose from hard plastic bowl.

FIG. 2—106— A common household 110 volt electric plug which can be used as a power source or charging station for the unit when used in a fixed application.
107— Also referred to in FIG. 1 as 100 a solid (1) piece bowl—not retractable
108— Water supply line— 3/16 to 5/16 plastic used to supply fresh liquid to the top ring 115 for rinsing Saliva down the bowl to the exit 105 as shown in FIG. 1
109— Disposal and or discharge line ⅜″-¾″ plastic hose used to collect and drain Saliva from the bottom of the bowl to the collection vessel 113.
110— Electrical wiring from the unit that can be connected Direct to 12 volt power or AC wall unit by using a power converter that would reduce the 110 voltage to a usable 12 volt power source.
111— DC battery 12 Volt that can be carried with the unit as a mobile unit. Smaller 12-Volt systems may incorporated directly into the 104 handle, used to make the unit compact and lightweight for travel.
112— Clean Liquid supply bag for rinsing saliva from bowl, size and volume of the bag or container may vary depending on the application need or design for use. some reference measurements may include 2″ high-8″ wide-8″ long (to) 4″ high-10″ wide-8″ long
113— Waste/discharge bag for bowl plastic. (sizing) size and volume of the bag or container may vary depending on the application need or design for use. some reference measurements may include 2″ high-8″ wide-8″ long (to) 4″ high-10″ wide-8″ long
114— Electrical quick disconnect for 12-volt and 110 adapters for AC use as well as charging using 110 circuit. The quick connect also houses the ability to connect new liquid sanitary line to either, without disconnect.

FIG. 3—115— Some units designed for travel and space requirements may have retractable bowl—from 3″-7″ in height

FIG. 4—116— Saliva bowl may be a hard plastic bowl used with the detachable cleansing ring system.

FIG. 5—117— Locking system to connect the dispenser bowl to the control handle 104a, used on all types of bottom containers.
118— Replaceable dispenser bag with locking system 118 to allow for travel and limited use of unit when portable.

FIG. 6—119-120— Shows the Saliva dispenser mounted to the back of a wheelchair, with the user holding the container for use.

FIG. 7—121—Reveals the placement of the carrying case as positioned on the back side of the wheelchair, without hindering the function of the chair while allowing the tubes reach to the individual for proper use without restraint.

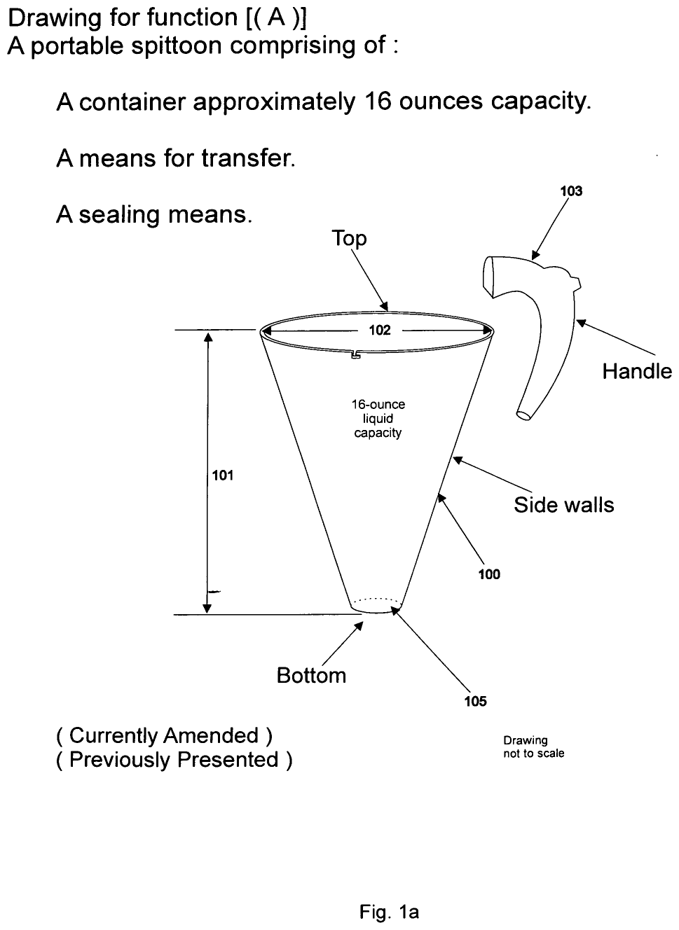

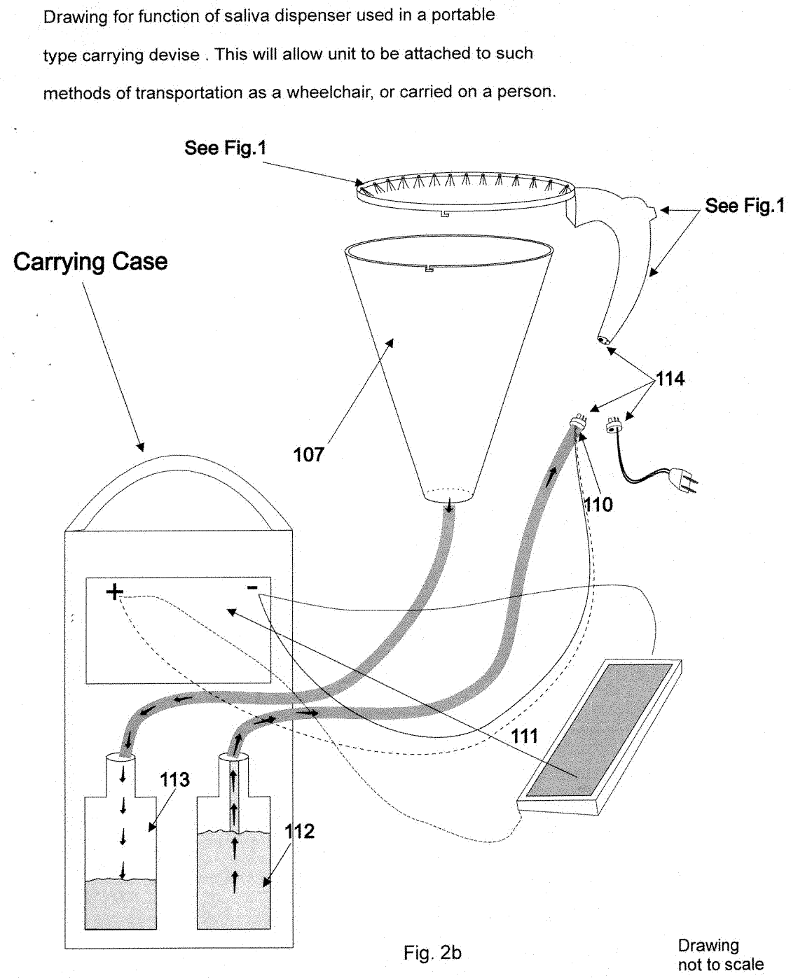

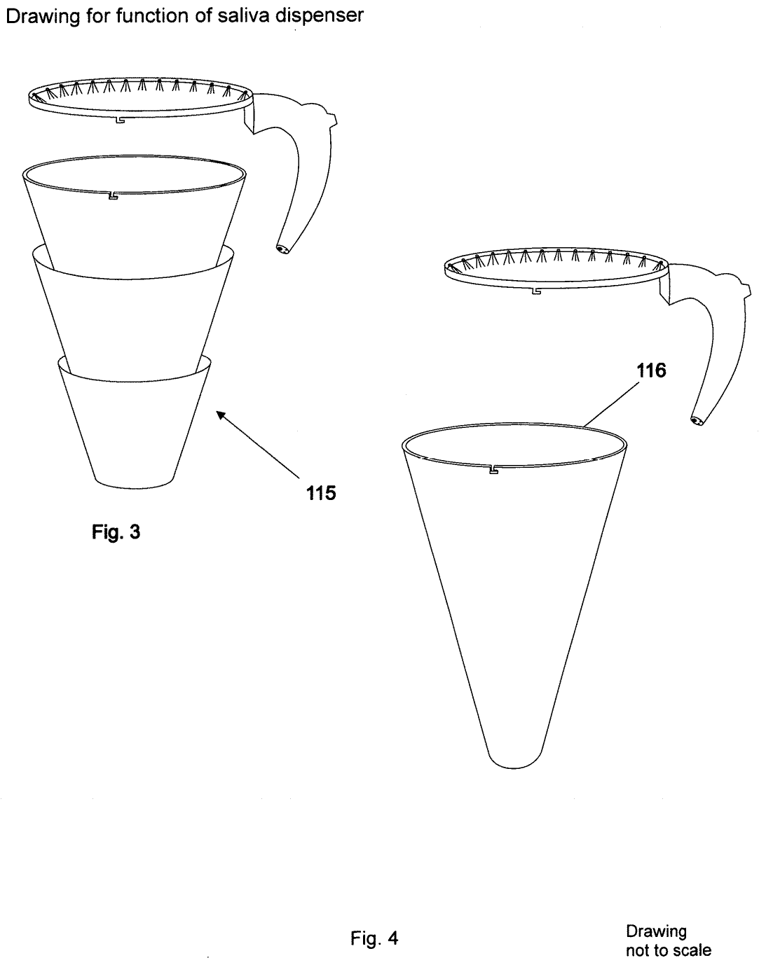

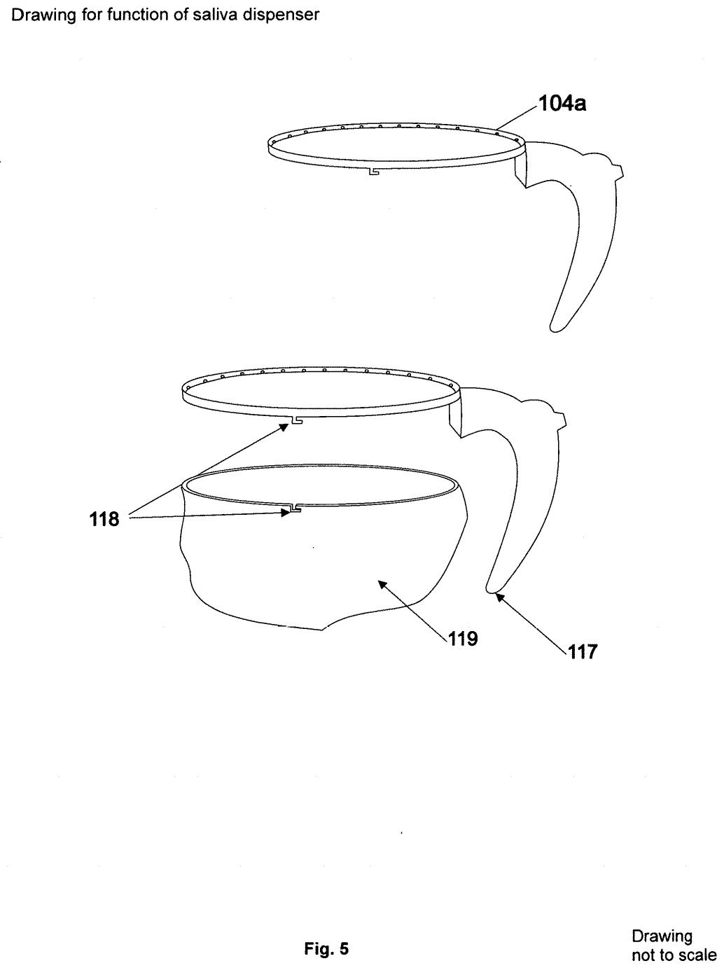

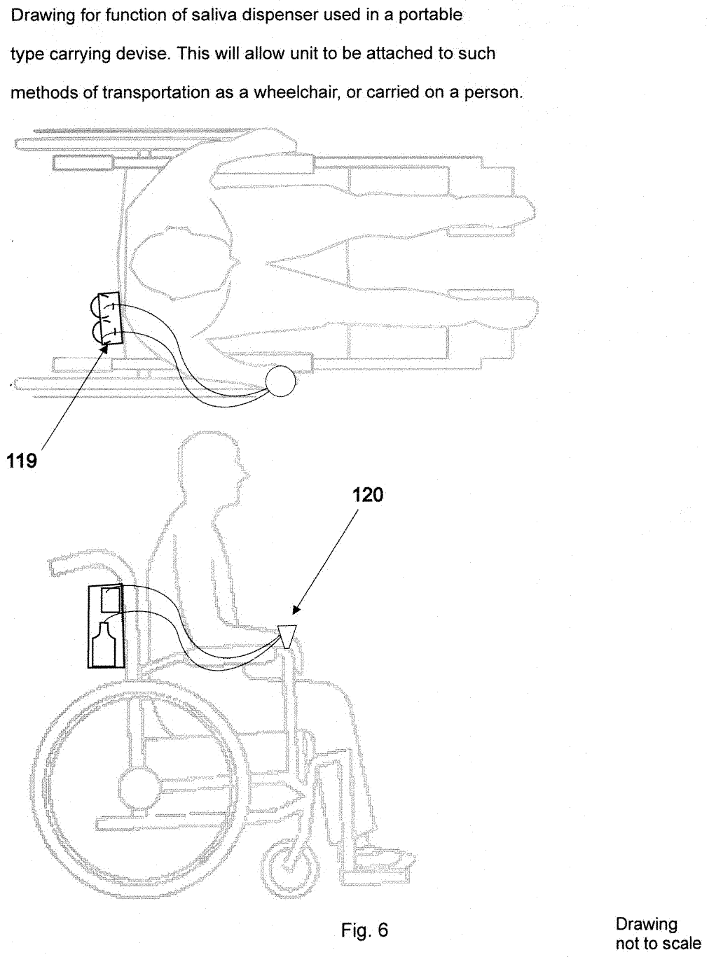

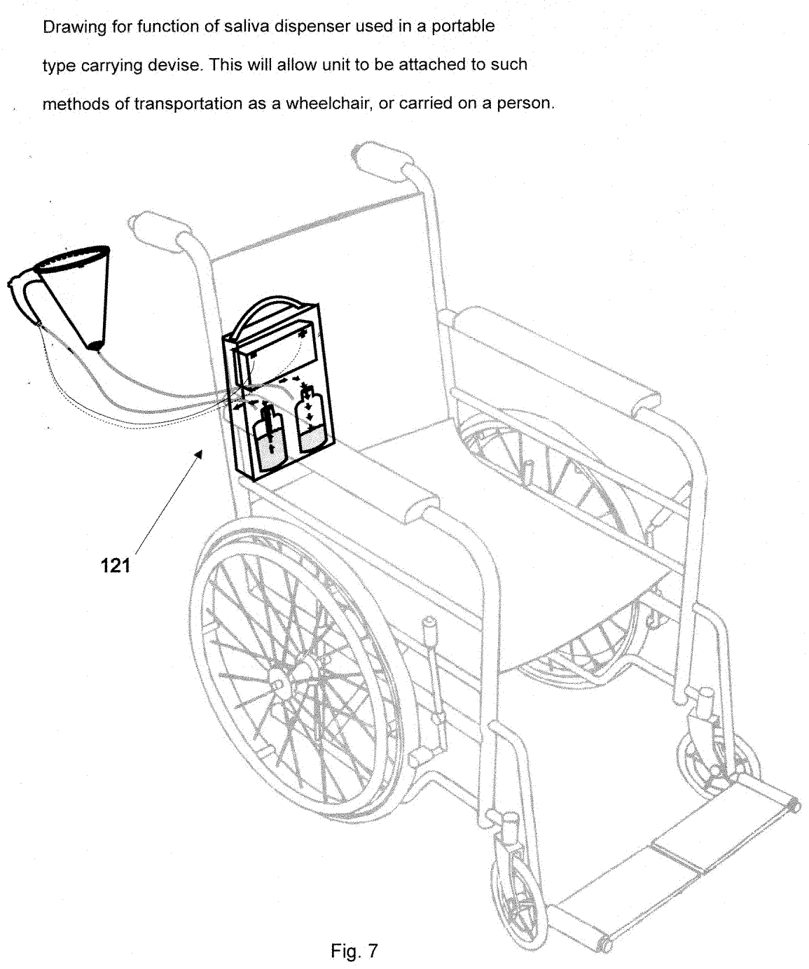

The invention claimed is:

1-15. (canceled)

16. A portable spittoon comprising: a container including a bottom, side walls and an opening adjacent to a top; a removable lid mounted to the top of said container, the lid having a top surface, side walls and an open bottom, the open bottom including a funnel-shaped portion having an opening leading into the container; means for transferring secretions from a user's mouth into the container; a sealing means being movable between a closed position and an open position with respect to the funnel-shaped portion; and an actuator operatively connected with the sealing means for moving the sealing means from the closed position to the open position.

17. The portable spittoon as set forth in claim 16, wherein the means for transferring secretions from the user's mouth into said container is an opening in a side wall of the lid.

18. The portable spittoon as set forth in claim 16, wherein the sealing means is a flexible seal.

19. The portable spittoon set forth in claim 16, wherein the sealing means is adjustable such that constant contact with the funnel-shaped-portion can be maintained in the closed position.

20. The portable spittoon as set forth in claim 16, wherein the actuator includes an actuating rod to which the sealing means is connected such that the actuating rod moves the sealing means from the closed to the open position when actuated.

21. The portable spittoon as set forth in claim 16, further comprising a handle and having an actuating rod. The actuating means further includes a spring means for forcing the sealing means back into the closed position when the actuating rod is not actuated.

22. Containing a actuating rod that extends through the lid and a valve button is connected to the portion of the actuating rod which moves the lid from closed position to the open position when the button is actuated.

23. The portable spittoon as set forth in claim 20, wherein the actuating rod extends through the center of the lid, such that the perimeter of the sealing means is constant, equally distributed contact with the funnel-shaped portion.

24. Claim 16 wherein, the actuating means includes a locking means for temporarily disabling the actuating means such that the sealing means remains in the closed position.

25. The portable spittoon as set forth in claim 16 wherein, the valve button includes a locking means for the temporary prevention of the actuation of the valve button such that the sealing means remains in the closed position.

26. The portable spittoon as set forth in claim 16 wherein, the container further includes a means for monitoring the status of the container contents.

27. The portable spittoon as set forth in claim 16 wherein, the means for monitoring the contents of the container is a window constructed in the side of the wall of the container.

28. The portable spittoon as set forth in claim 16, further comprising a container with a removable lid.

29. The portable spittoon as set forth in claim 16, further comprising a window constructed in the side wall of the container.

30. The portable spittoon as set forth in claim 16, further comprising controlling components contained in a portable carrying case for use on a wheel chair.
